(19) United States
(12) Patent Application Publication
(10) Pub. No.: US 2020/0346965 A1
(43) Pub. Date: Nov. 5, 2020

(54) BENDING GLASS BY GRAVITY BETWEEN SKELETON AND COUNTER-SKELETON

(71) Applicant: SAINT-GOBAIN GLASS FRANCE, COURBEVOIE (FR)

(72) Inventors: Christophe MACHURA, CHEVINCOURT (FR); Thierry OLIVIER, THOUROTTE (FR); Philippe FREBOURG, SENLIS (FR); Jérôme PELLETIER, GUIGNIERES (FR)

(21) Appl. No.: 16/755,017

(22) PCT Filed: Oct. 18, 2018
(86) PCT No.: PCT/FR2018/052596

§ 371 Date: Apr. 9, 2020

(30) Foreign Application Priority Data
Oct. 19, 2017 (FR) 1759859
Oct. 19, 2017 (FR) 1759862

(51) Int. Cl. C03B 23/025; C03B 40/00

(52) U.S. Cl. CPC C03B 23/0256; C03B 2225/02; C03B 40/005

(57) ABSTRACT

A device and a method for bending, by gravity, a sheet of glass or a stack of sheets of glass including a plurality of sides, called the glass, including a skeleton for supporting the glass in its peripheral zone by a contact track, the contact track including concave curvatures on each of the sides of the skeleton, and a counter-skeleton capable of entering into contact with the glass in the zone of the middle of at least one side of the peripheral zone of the top main face of the glass.

The invention relates to the bending of glass by gravity on a skeleton. A counter-skeleton is arranged above the glass in order to avoid the formation of ripples at its edges.

Bending glass by gravity is well known and in particular documented in EP448447, EP0705798 and EP885851. In US999558, the glass is forced to bend by pressure on the edge.

Bending sheets of glass of a thickness greater than 2.1 mm by gravity can be performed by methods described in the prior art. The trend is to increasingly reduce the thickness of the sheets of glass intended to be assembled in laminated glazing. The trend is to associate a thin sheet, with a sheet of greater thickness. It has been found that the bending of a sheet of glass of a thickness less than or equal to 2.1 mm by gravity produced, on a conventional skeleton, ripple defects on the edges of the glass, more particularly in the zone of the middle of the various sides of the glass. The phenomenon responsible for creating folds at the periphery of the glazing while it is supported at the periphery is an instability phenomenon similar to the buckling (or warping) of elastic plates. As in the case of thin elastic plates, the peripheral instability phenomenon observed in the forming of sheets of glass is all the more marked when the thickness of the glass is small and the temperature at the periphery of the glass is high.

If the formation of these ripples is sought to be counteracted by pressing on the top face of the glass during the bending, that tends to produce marks on this face and on the bottom face, and even to hamper the bending since the glass is wedged between a bottom tool and a top tool, like in a jaw, which slows down its subsidence. The “marks” correspond to slight mechanical indentations created by the tools on the glass while it is being bent. They are particularly damaging when they are situated on the bottom surface of the glass during the bending because they are then visible from the outside of the vehicle. The glazing is then scrapped. The “marks” which are situated on the top face of the glass during the bending are generally more readily accepted because they are located inside the vehicle once mounted thereon and these imperfections are therefore hidden from the view of an observer outside the vehicle. Also, these marks inside the vehicle are hidden only if they are on the periphery of the glazing and therefore in the zone of bonding of the interior glass on the body.

According to the invention, the bending of glass, in particular of thin glass, is correctly performed using a device for bending, by gravity, a sheet of glass or a stack of sheets of glass comprising a plurality of sides, called the glass, comprising a skeleton for supporting the glass in its peripheral zone by a contact track, said contact track comprising concave curvatures on each of the sides of said skeleton, and a counter-skeleton capable of entering into contact with the glass in the zone of the middle of at least one side of the peripheral zone of the top main face of the glass. Preferably, the counter-skeleton enters into contact with the zone of the middle of all the sides, generally four sides, of the peripheral zone of the top main face of the glass. The peripheral zone is the zone between the edge of the glass and a distance from the edge of the glass of 50 mm, whether it be the top face or the bottom face of the glass. Preferably, the counter-skeleton is removable (synonym: retractable).

The invention relates also to a method for bending, by gravity, a sheet of glass or a stack of sheets of glass, called the glass (which has a thickness e), comprising the bending of the glass by gravity on a skeleton comprising a contact track supporting the glass in the peripheral zone of its bottom main face, a counter-skeleton comprising a metal bar being in contact with the glass during the bending in the peripheral zone of its top face, at the points where ripples appear in the absence of the counter-skeleton. The method comprises the bending of the glass by gravity on a skeleton supporting the glass in its peripheral zone by a contact track, said contact track comprising concave curvatures on each of the sides of said skeleton, a counter-skeleton coming into contact with the glass in the zone of the middle of at least one of the sides of the glass in the peripheral zone of its top main face.

The glass placed on the skeleton can be an individual sheet of a thickness less than or equal to 2.1 mm, even of a thickness less than or equal to 1.2 mm. Generally, the thickness of an individual sheet is greater than or equal to 0.4 mm. The glass placed on the skeleton can also be a stack of sheets of glass, in particular of sheets whose thicknesses have just been given. The stack can also comprise sheets of different thicknesses. This stack can comprise 2, 3 or 4 sheets. It is in particular possible to use the device according to the invention to bend the following two sheets in the superposed state: one sheet whose thickness lies in the 1.4 to 2.7 mm range, generally in the 1.4 to 2.5 mm range, with a sheet whose thickness lies within the 0.4 to 1.6 mm range, in particular in the 0.4 to 1.2 mm range, the thicker sheet being preferably located under the thinner sheet during the bending on the skeleton. The sheets bent together by the device according to the invention are not necessarily intended to be joined together in one and the same laminated glazing. For the purposes of simplification, the terms “the glass” is employed to denote an individual sheet or a stack of sheets.

The skeleton supports the bottom main face of the glass in its peripheral zone. The skeleton comprises a metal band (that can also be called “vertical flat”, even though its large faces can possibly be inclined) having one of its edges uppermost to support the periphery of the glass. The skeleton also comprises, as covering on the top edge of its metal band, a refractory fibrous material that is well known to the person skilled in the art, forming the contact track for the glass. The metal band is rigid whereas the fibrous material has a certain elasticity and compressibility. This material is generally of the felt type or a knit or fabric of metallic and/or ceramic refractory fibers, as is well known to the person skilled in the art. These materials reduce the risk of marking of the glass by the skeleton. The metal band in the skeleton generally has a width lying within the 1 to 10 mm range. The fibrous material generally has a thickness lying within the 0.3 to 1 mm range. The skeleton offers the glass, via its refractory fibrous material, a contact track of a width generally lying within the 1.6 to 12 mm range (which includes the thickness due to the refractory fibrous material), more generally within the 3 mm to 10 mm range. The skeleton has, on its contact face for the glass, concave curvatures, and has these for each of its sides and generally at least in the middle of each of its sides, generally four sides. The contact track of the skeleton has concave curvatures for at least 80% and generally at least 90% of its length, said concavity being considered parallel to its outlines (internal or external). The contact track of the skeleton has concave curvatures for at least 80% and generally at least 90% of the length of its longitudinal sides, said concavity being considered parallel to its outlines (internal or external). In particular, the contact track of the skeleton has concave curvatures for the zone of the middle of its longitudinal sides, in particular for at least up to 20 cm of each side from this middle. The contact track of the skeleton has concave curvatures for at least 80% and generally at least 90% of the length of its transverse sides, said concavity being considered parallel to its outlines (internal or external). In particular, the contact track of the skeleton has concave curvatures for the zone of the middle of its transverse sides, in particular for at least up to 20 cm of each side from this middle. The glass subsides under the effect of gravity on the skeleton during the bending and assumes a concave form when seen from above (the concave face is the top face) in its central zone and on each of its sides, in particular in the middle of its sides. The skeleton has a form conferring this concavity, since, at the end of bending, the glass touches all the perimeter of the contact track of the skeleton. At the end of bending, the glass being placed on the skeleton, the central zone of the top face of the glass is concave in all the directions. Seen from above, the skeleton has substantially the same outline as the glass that it has to receive while being smaller since the glass extends beyond all the outer perimeter of the skeleton. The contact track of the skeleton therefore generally has a concave form on each of its sides, in particular in the middle of its sides. The skeleton has as many sides as the glass and therefore generally has four sides (also called “bands”). Before bending, the glass generally extends beyond all the perimeter of the skeleton by a distance lying within the 2 to 45 mm range. This extension diminishes during the bending. This diminution depends on the scale of the curvatures given to the main faces of the glass during the bending. At the end of bending, this extension generally lies within the 1 to 25 mm range. From the start to the end of the bending, the skeleton generally supports the glass entirely within its peripheral zone and without extending out of this zone, either outward or inward. Seen from above, the skeleton has a continuous and uninterrupted annular form. Indeed, if the skeleton were segmented, this segmentation could produce a mark on the bottom face of the glass given the fact that, in the method according to the invention, the glass subsides essentially solely under the effect of its weight and therefore fairly readily follows the form of its support and remains fairly sensitive to the unevennesses of the skeleton.

The invention relates more particularly to the bending of glass for the production of glazings intended to equip vehicles (motor vehicles, buses, trucks, agricultural vehicles, etc.). It can be a windshield, a rear window, roof, sliding or fixed side window. The glass considered here comprises a plurality of sides, generally four sides (also called “bands”), one side meeting another at a corner of the glass, this corner comprising a curved sector comprising radii of curvature very much smaller than those of the curvature of the sides. The radii of curvature of the perimeter of the main faces seen at right angles to the main faces and to the edge of the glass are taken into consideration here. The middle of a side is located substantially equidistantly from two corners of this side. Such glasses have a vertical plane of symmetry PS when they are mounted on the vehicle, the direction of displacement of the vehicle (steering wheel not turned) lying within this plane of symmetry. The sides intersecting with this plane of symmetry are called transverse sides, the two other sides being called longitudinal sides. The middle of the sides is found as follows: the bent glass (preferably in the non-deformable assembled glazing state) is placed on a horizontal plane, concave side downward. The glass touches the horizontal plane by 4 points of contacts at its corners. The points of contact are linked to one another by straight-line sectors. The intersection with the edge of the glass of the plane at right angles to the sector and passing through the middle of this sector is the middle of the side of the glass. The middle of the transverse sides is also located at their intersection with the vertical plane of symmetry PS.

It is observed that the glass ripple problems mainly occur in the middle of the sides and, to remedy this problem, the counter-skeleton comes into contact with the glass in the zone of the middle of at least one of its sides and generally in the zone of the middle of all of its sides. The counter-skeleton can also enter into contact with the glass in the peripheral zone out of the zone of the middle of a side and even above the corners of the glass, but that is not generally necessary. The counter-skeleton can therefore possibly be absent above corners of the glass, the glass being better formed at these points. This is in particular possible when the complexity of the glazing is not too excessive, typically when its main bow is less than 100 mm. The zone of the middle of a side is the zone surrounding this middle in the peripheral zone of the glass. In particular, the zone of the middle of a side is the peripheral zone in the vicinity and on either side of the middle, at least up to 5 cm on each side of the middle, and even at least up to 10 cm on each side of the middle, and even at least up to 20 cm on each side of the middle, parallel to the edge of the glass and in the peripheral zone. This zone of the middle of a side is entirely concave at least up to 20 cm on each side of the middle. The counter-skeleton bears on the glass in this zone, but not necessarily throughout this zone. The counter-skeleton bears sufficiently to prevent the formation of the ripples, but not enough to mark the glass. The counter-skeleton bears, if necessary continuously, throughout the length of this zone parallel to the edge of the glass, but generally not throughout the width of this zone. If appropriate, the contact with the glass can therefore be only partial, that is to say along the periphery of the glass, the counter-skeleton may touch the glass only in certain zones and not in others. The counter-skeleton is preferably facing the skeleton on the other side of the glass during the bending. However, it may be located a little offset inward or outward relative to the skeleton, but its contact with the glass is made preferably only in the peripheral zone of the top face.

The glazings targeted here generally have four corners and are symmetrical relative to their plane of symmetry passing through the middle of their transverse sides. The two transverse sides are generally of a length lying within the range from 80 cm to 250 cm (length of sectors between points of contact, when the glazing is placed on a horizontal plane with the concave face turned downward). The two longitudinal sides generally have a length lying within the range from 60 cm to 180 cm (length of sectors between points of contact, when the glazing is placed on a horizontal plane). The two longitudinal sides generally have the same length.

The counter-skeleton comprises a metal bar at least partially covering, when seen from above, the peripheral zone of the top face of the glass. The counter-skeleton has a form complementing that which has to be given to the glass (final form after bending at the periphery), at the point where it touches the glass. Its form can deviate from that of the glass (and therefore of the skeleton) at the point where it does not touch the glass. The counter-skeleton has convex curvatures to face the concave curvatures of the top face of the glass. Since the skeleton has the form of the glass, the counter-skeleton has curvatures parallel to those of the skeleton, at least at the point where the counter-skeleton touches the glass.

The counter-skeleton enters into contact with the glass by a refractory fibrous material. At the points where the counter-skeleton touches the glass, it preferably has a structure similar or identical to that of the skeleton, that is to say that its metal bar comprises a metal band (or vertical flat) having one of its edges downward, said bottom edge being possibly covered with a refractory fibrous material already described for the skeleton. All the materials and thicknesses given for the skeleton (metal band and refractory fibrous material) are then valid for the counter-skeleton.

The refractory fibrous material can be compressed and is compressed during the bending under the effect of the force of gravity acting on the counter-skeleton. This property of the fibrous material can be exploited to distribute the pressure exerted by the counter-skeleton on the glass. The beneficial effect on the reduction of the unwanted peripheral ripples is also associated with the mechanical effect of the two tools (skeleton and counter-skeleton) which physically prevent any possibility of the glass being deformed in a vertical direction in line with the tools. The beneficial effect is linked to the use of the refractory fibrous material coupled with the control of the gap between the skeleton and the counter-skeleton; a slight local modulation of the distance between these two tools is reflected by a light compression of the fibrous material, which is insufficient to induce a mark on the glass. If necessary, a system of counterweights linked to the counter-skeleton reduces the force of pressure of the counter-skeleton on the glass.

Two variants can be distinguished:
V1: the counter-skeleton touches the glass and the fibrous material is compressed under the effect of the force of gravity being exerted on the counter-skeleton, but its compression is limited by virtue of the presence of a means of imposing a given minimal separation Dm between the metal band in the skeleton and a metal bar in the counter-skeleton.
V2: the counter-skeleton touches the glass and the fibrous material is compressed under the effect of the pressure exerted by the counter-skeleton, but its compression is not blocked by a means of imposing a given minimal separation between the metal band in the skeleton and a metal bar in the counter-skeleton.

The variant V1 involves the use of a means of imposing a given minimal distance Dm between the metal band of the skeleton and the metal bar of the counter-skeleton. The skeleton and the counter-skeleton cannot come close enough to one another for the distance between the metal band of the skeleton and the metal bar of the counter-skeleton to drop below Dm. This means serves to prevent the counter-skeleton from exerting an excessive pressure on the glass. In addition to the reduction of the risk of marking of the glass, that also allows the glass to slide over the skeleton during the bending, without being retained because of an excessive clamping between skeleton and counter-skeleton. This favors obtaining bending cycle time.

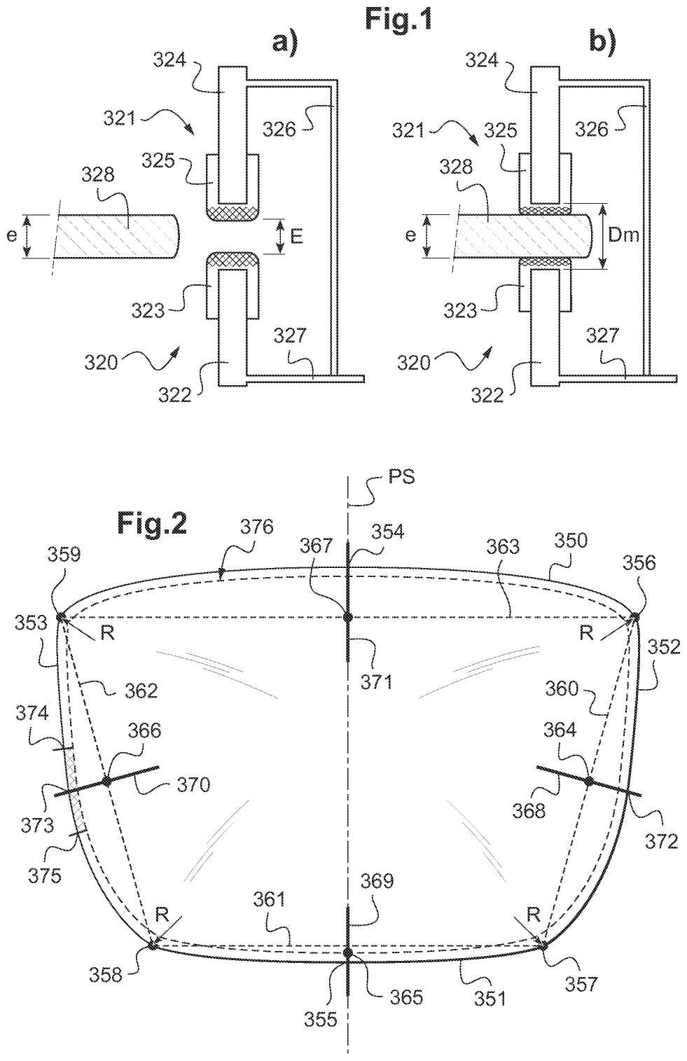

The curvatures of the glazings are characterized by the concepts of bow and of double-bending. For the definitions of these characteristics, reference can be made to FIGS. 1a and 1b and to the description corresponding to them in WO2010/136702.

The invention is perfectly suitable for bending glass in which the complexity of form is moderate (bow less than 100 mm and/or double-bending less than 20 mm) or greater (bow greater than 100 mm and/or double-bending greater than 20 mm).

The variant V1 is preferably used when the geometrical instability (ripples) occurs in a highly localized manner on the glazing such as, for example, at the middle of the top band of a windshield (horizontal top edge when mounted on the vehicle). The distance between the skeleton and the counter-skeleton in this particular region then has to be finely adjusted. It is naturally possible to use this variant V1 over all the periphery of the glass, particularly when the propensity to geometrical instabilities is distributed over all the periphery of the glass.

The variant V2 is preferably used when the adjustment of the distance between the skeleton and the counter-skeleton is particularly difficult. This variant V2 operates not by adjusting the geometrical dimensions, but by pressure by virtue of the force of gravity exerted on the counter-skeleton pressing on the glass. This type of tool results in a bending method that is particularly reproducible, but less sensitive to the small geometrical variations of the tools, in particular for different successive heating and cooling cycles.

The function of the counter-skeleton is not to bend the glass (that is the role of gravity), but simply to prevent the formation of edge ripples. A bending without the counter-skeleton would culminate in an identical bending in the central zone of the glass compared to a bending with counter-skeleton, all other production conditions being the same. In particular, the counter-skeleton must not press too strongly on the glass because that would be reflected by a clamping of the glass, hindering its sliding on the skeleton during the bending and slowing down, even preventing, its bending. This is why the pressure exerted by the counter-skeleton has to be finely apportioned. In the device according to the invention, preferably, during the bending the counter-skeleton exerts a weight on the glass per linear meter of counter-skeleton (parallel to the skeleton) less than 2 kg/m and preferably less than 1 kg/m. Preferably, the counter-skeleton exerts a weight on the glass per linear meter of counter-skeleton (parallel to the skeleton) greater than 0.1 kg/m.

The counter-skeleton acts positively (by reducing the ripples) on the glass by thermal effect, at the points that it touches as at the points that it does not touch but that it approaches, notably to less than 50 mm. This thermal effect depends essentially on three criteria: 1) the relatively moderate temperature of the counter-skeleton on entering the kiln, preferably less than 250° C., 2) the propensity of the counter-skeleton to remain colder than the periphery of the glass while the glass is between 300 and 650° C., and in particular during the bending, 3) the area of glass exposed to the counter-skeleton.

The criterion 1 is ensured by a sufficient cooling of the counter-skeleton after a bending has been performed. A part of this cooling takes place in the bending kiln itself but also on the line of return of the tools when they go back from the kiln exit to the kiln entry. Complementary cooling systems specifically dedicated to the cooling of the counter-skeleton can be installed, such as additional fans or air jets directed toward this tool. It is also possible to provide a dedicated cooling circuit, directly fixed to the counter-skeleton, and activated over its return path out of the kiln. It can in particular be a tube capable of receiving a current of a coolant of fresh air (that is to say air generally at ambient temperature, generally between 0 and 50° C.). Such a metal tube can be attached to the metal bar of the counter-skeleton. It can also be a counter-skeleton whose metal bar comprises a metal tube with square or rectangular section in which fresh air is made to circulate. The criterion 2 is ensured, either by increasing the mass of metal embedded in the counter-skeleton, with the result of increasing its thermal inertia and therefore the quantity of heat needed to reheat it, or by limiting heat supplied to the counter-skeleton by covering the latter with a thermal insulation. Thus, the heating elements arranged in the crown of the kiln can heat the glass without in any way pointlessly losing energy to directly reheat the counter-skeleton. The periphery of the glass is then all the colder since it is on the one hand concealed from the direct heating by the heating elements of the kiln (generally in the crown) and on the other hand since it faces the counter-skeleton which is kept at lower temperature. It should be noted that the cooling of a counter-skeleton coated with an insulating material is slower because the surface directly exposed to the open air on the line of return of the tools is reduced. The criterion 3 is a function of the geometry of the counter-skeleton and of the distance between the counter-skeleton and the glass.

The counter-skeleton can be segmented. It then comprises as many bands (or “segments”) as the glass a has sides, generally four. One side of the glass has a band of the counter-skeleton associated with it. Each band of the counter-skeleton can cover the zone of the middle of one side, and if necessary, not go as far as the corners of the glass.

According to the invention, the skeleton can comprise a metal band whose edge is directed upward, said edge being covered with a refractory fibrous material forming the contact track for the glass, the counter-skeleton can comprise a metal bar, the device comprising a means of imposing a given minimal distance Dm between the metal band of the skeleton the metal bar of the counter-skeleton. The means of imposing Dm can in particular comprise a limit stop-forming element, called limit stop, secured to the skeleton and on which a prop-forming element, called prop, secured to the counter-skeleton, can rest. The limit stop is fixed directly or indirectly to the rigid metal band of the skeleton. It can be the top surface of a plurality of pillars or jack screws. The prop is fixed directly or indirectly to the rigid metal bar of the counter-skeleton. The device generally comprises a frame on which the skeleton is fixed. Any limit stop element can be fixed onto the frame or onto the skeleton, which still amounts to the fact that the limit stop is secured directly or indirectly to the skeleton. Advantageously, the means of imposing Dm can be adjusted so as to adjust the value of Dm. That makes it possible in particular to adjust the degree of compression of the refractory fibrous material with which the counter-skeleton and the skeleton are equipped and that presses on the glass, and therefore the pressure on the top face of the glass and the pressure on the bottom face of the glass. The adjustment means can be situated at the limit stop and/or the prop.

In practice, the distance between the two tools (skeleton and counter-skeleton) can be adjusted and controlled by the tool makers using shims. For the adjustment of the heightwise dimension of the counter-skeleton, the tool maker can proceed by introducing a shim between the top face of a previously bent glass and the refractory fibrous material of the counter-skeleton by exerting a certain lateral effort. In this adjustment, the fibrous material contracts slightly and diminishes a little in thickness. The rib measurement performed by the tool maker is therefore the resultant of the distance between the glass and the counter-skeleton, of the thickness of the fibrous material which covers it, of the compressibility of the fibrous material, of the thickness of the shim itself, and of the lateral force exerted by the tool maker when checking or when adjusting the distance between the two tools. By proceeding in this way, the operator appreciates whether a given shim passes easily or not between the glass and the counter-skeleton and, by routine tests, he or she learns to finely adjust the device.

For the case of pronounced curvatures or of complex forms, in particular including pronounced curvatures in mutually orthogonal directions, it may be advantageous for the device according to the invention to comprise a system capable of modifying the distance between the skeleton and the counter-skeleton during the bending. In fact, the counter-skeleton has a form closer to that of the top face of the glass at the end of the bending, rather than at the start of the bending. Now, when the glass is placed on the skeleton, the glass is flat or only slightly bent by virtue of its natural flexibility. The counter-skeleton therefore has a more curved form than the glass at the start of the bending and could touch it and, by elastic deformation, force it to adopt the peripheral form of the skeleton. Such a situation risks resulting in the glass breaking on entering the kiln. This is why, without precluding the counter-skeleton from being able to touch the glass from the start of the bending (on entering the kiln), it may be preferable for the counter-skeleton to first of all be fairly far away from the skeleton then approach it during the bending. The gap between the counter-skeleton and the glass (and therefore between the counter-skeleton and the skeleton) is then reduced as the glass softens and molds to the contours of the skeleton. The duration of the phase of convergence between the glass and the counter-skeleton can be adjusted between five tenths of a second and 30 seconds, even up to a minute, depending on the previous thermal history and the complexity of the glazing itself.

If the efforts applied to the glass on entering the kiln and during the bending are moderate enough to avoid a breaking of the glass, it is on the one hand perfectly possible for the counter-skeleton to be in partial contact with the glass, particularly at the middle or in proximity to the middle of the top and bottom sides of the glass (in position mounted on a motor vehicle) from kiln loading and, on the other hand, it is possible to force the glass to be bent by the action of the counter-skeleton pressing on the glass. The counter-skeleton presses on the glass as it is lowered, which forces the peripheral bending. Such a kinematic scenario is advantageous because it makes it possible to simplify the main bending of the glass and thus reduce the forming cycle time. Note that, at the start of the method towards entering the kiln, the glass is at low temperature and less sensitive to the marking and that is why apart from the case of breakage, the fairly insistent contact of the counter-skeleton at this stage is not necessarily a problem, and can even be advantageous. The triggering of the convergence between glass and counter-skeleton can be relatively abrupt (simple triggering, that is to say switching in one go from a separated configuration to a close configuration) or else gradual. A triggering system can be actuated through the lateral walls of the kiln or else through the bed of the kiln. A triggering system can in particular be similar to that described in U.S. Pat. No. 8,156,764. As an example, the distance between the glass and the counter-skeleton in the zone of the middle of a side can lie within the range from 0 to 10 mm at the start of the bending, to finish at 0 mm at the end of bending while, concomitantly, the distance between the glass and the skeleton in the zone of the middle of a side can lie within the range from 0 to 300 mm at the start of the bending to finish at 0 mm at the end of bending. Thus, the skeleton and the counter-skeleton can possibly converge gradually during the bending.

According to the embodiment V2, the counter-skeleton touches the glass and no limit stop/prop system stops the progress of the counter-skeleton toward the glass (and therefore also toward the skeleton) under the effect of gravity. The glass itself acts as limit stop. In this case, the counter-skeleton rests on the glass, which results in a greater or lesser compression of the fibrous material with which it is equipped. If the counter-skeleton is relatively light, it can be allowed to rest by all of its weight on the glass. If the counter-skeleton is too heavy and exerts an excessive pressure on the glass despite the presence of the fibrous material with which it is equipped, a part of the weight of the counter-skeleton can be compensated by a system of counterweights. In this case, the weight of the counter-skeleton is lightened by a counter-weight acting at the end of a lever. This lever is linked to the frame supporting the skeleton by a pivot link with substantially horizontal axis, one end of the lever bearing the counter-skeleton, the other end of the lever being linked to the counter-skeleton and pulling the latter upward under the effect of the counterweight at the other end of the lever.

The invention also relates to a method for bending glass by gravity, using the device according to the invention. The bending of the glass is performed by gravity on a skeleton supporting the glass in its peripheral zone, a counter-skeleton coming into contact with the glass in the zone of the middle of at least one of the sides of the glass in the peripheral zone of its top main face. In particular, the glass is bent by gravity at a temperature lying within the range from 570 to 650° C., more generally within the range from 610 to 650° C. To produce this bending, the skeleton/counter-skeleton charged with glass can be conveyed through a tunnel kiln raised to the plastic deformation temperature of the glass. This kiln can be passed through by such assemblies each charged with glass and circulating one behind the other in the kiln, the skeleton and the counter-skeleton forming a carted assembly capable of being conveyed together horizontally but without horizontal displacement relative to one another. The kiln can comprise different temperature zones for gradually heating then gradually cooling the glass.

The glass is in contact with the skeleton for more than 10 minutes and generally more than 15 minutes and more generally between 15 and 30 minutes in the kiln while being conveyed in the kiln. In the kiln, the glass undergoes a rise in temperature, the bending and after bending, a controlled lowering of the temperature. Likewise, in the kiln, the counter-skeleton generally also touches the glass for longer than 10 minutes and generally at the same time as the glass touches the skeleton. The bending is performed by gravity. In the absence of counter-skeleton, during the bending, the glass would touch all of the skeleton, then, certain zones (in particular in the zone of the middle of at least one side of the peripheral zone) would be raised to no longer have contact with the skeleton. The counter-skeleton serves to prevent this raising of the glass and guarantee a total contact of the glass with all the contour of the skeleton at the end of bending. The skeleton and the counter-skeleton form a carted assembly capable of being conveyed in the kiln by a conveying means. The device according to the invention does not allow a relative horizontal displacement of the skeleton and of the counter-skeleton relative to one another, even as the skeleton/counter-skeleton assembly is conveyed in the kiln. The device can comprise means allowing the skeleton and the counter-skeleton to move closer or further apart by a relative vertical movement without relative horizontal displacement relative to one another, and do so even as the skeleton/counter-skeleton assembly is conveyed in the kiln. The term “relative” qualifying a movement means that the latter can be attributable to the counter-skeleton alone or the skeleton alone or both these elements. The absence of relative horizontal displacement of the skeleton and of the counter-skeleton relative to one another means that these two elements remain facing one another when seen from above during the horizontal displacement of the skeleton/counter-skeleton assembly during the bending in the kiln. Thus, the device according to the invention generally comprises a kiln and a conveying means capable of horizontally displacing the skeleton and the counter-skeleton together in the kiln while they are facing one another, and vertical translation means allowing the skeleton and the counter-skeleton to approach one another or move away from one another by a relative vertical movement during their horizontal displacement and without relative horizontal displacement relative to one another. If necessary, the device can be such that a counter-skeleton can be placed on a glass before entering the kiln and be removed after exiting from the kiln.

After bending, the glass is cooled. For this cooling and in order not to generate excessive edge extension stresses in the glass, the counter-skeleton is advantageously moved away from the glass. The separation of the counter-skeleton is advantageously performed during the cooling of the glass and when the latter is at a temperature lying between 620 and 500° C. This separation can be performed by different systems. It can be a re-engaging system which performs the reverse function of the “triggering” described above. Alternatively, the counter-skeleton can be composed of laterally retractable bands, generally four of them. The bands of the counter-skeleton are separated vertically and laterally at the moment of retraction so as to be no longer above the top face of the glass. The system controlling the retraction of the bands can be similar to one of those described in U.S. Pat. No. 8,156,764, that is to say, for example, through the lateral walls of the kiln.

The skeleton and the counter-skeleton are advantageously independent of one another, that is to say that the counter-skeleton can then be separated entirely without any longer having a link with the skeleton. The glass can then be loaded on the skeleton then the counter-skeleton is put in place.

The loading of the glass on the device according to the invention can be performed manually. With the counter-skeleton separated, operators place the glass on the skeleton. Then, they place the counter-skeleton in its planned position. The position of the counter-skeleton is advantageously given by positioning means fixed to the skeleton or to the frame. These positioning means guide the counter-skeleton in its placement. This guidance is made possible for example by orifices in guiding tabs linked to the counter-skeleton and through which positioning columns pass.

The loading and unloading of the glass can also be automated, in particular using robots, one for the loading, the other for the unloading. The use of robots makes it possible to have accurate and reproducible movements as well as a reliant and tolerant coupling system between the skeleton and its associated counter-skeleton. This system according to which the counter-skeleton is entirely separable from the skeleton makes it possible 1) to have a minimum of functions embedded in the tool and thus minimize the weight thereof, which is an important energy consumption factor, 2) to minimize the risk of mechanical seizing and 3) to minimize the servicing operations, which are usually costly, on the forming tools.

Alternatively, the counter-skeleton can form part of a system directly embedded on the skeleton itself and capable of retracting counter-skeleton. To do this, by way of example, the counter-skeleton can be composed of four separate bands secured to the skeleton and which can be moved away from or rejoin one another by displacements that have both a horizontal component and a vertical component making it possible to move away from the glass, without slipping on the latter, while moving away laterally from the skeleton. Such a movement can be performed by a simple rotation whose axis is shrewdly chosen, in particular outside of the skeleton. When these bands move away, the skeleton becomes accessible for glass to be unloaded or loaded.

If the counter-skeleton is of too light a construction, its rigidity may be too weak and its form may alter slightly during its use, following the thermal constraints undergone in the heating and cooling cycles. In this case, it may possibly be observed that the gap between skeleton and counter-skeleton (and therefore between the metal band of the skeleton and the metal band of the counter-skeleton) is no longer uniform and as it was set initially. The glass may possibly be, at certain points excessively clamped between skeleton and counter-skeleton, reducing the bending at these points by preventing the glass from slipping on the skeleton. Thus, depending on the bending cases, a simple adjustment of gap only at the corners of the device, in particular by four jack screws, may prove insufficient. This is why, advantageously, the counter-skeleton comprises a structural element arranged above its metal bar, the structural element and the metal bar being linked to one another by a plurality of adjustable spacers making it possible to locally adjust the distance between the structural element and the metal bar. The structural element is rigid and non-deformable despite the multiple thermal heating and cooling cycles undergone to bend glass sheets industrially. It can be used as reference for adjusting the form of the metal bar. The structural element advantageously comprises a metal tube, in particular of framework type. This tube can in particular have a square or rectangular section. It can comprise lateral extensions to come above the adjustment zones, the top end of the spacers being linked to the extensions. The top end of the spacers can also be linked directly to the structural element. Thus, the counter-skeleton can comprise a structural element provided with a dimension greater than that of its metal bar, the structural element and the metal bar being linked by a plurality of adjustable spacers making it possible to locally adjust the distance between the structural element and the metal bar, and, locally, the counter-skeleton/skeleton distance. The plurality of spacers is distributed regularly over all the perimeter of the counter-skeleton.

In order to reduce to the minimum the risks of deformation of the counter-skeleton due to thermal constraints, its metal strip can be given the structure of a chain, by breaking down the counter-skeleton into a plurality of sectors linked to one another by articulations. A sector is a piece of metal band having one of its edges downward, said edge being covered or not, depending on the case, with a refractory fibrous material. A sector comprises a length and a height, its thickness being that of the metal band. Its length is substantially parallel to the edge of the glass and to the skeleton. The edge of the sector turned downward is substantially parallel to the edge of the skeleton at the same point. The sectors are linked to one another like a chain so that their edges directed downward are aligned and substantially parallel to the edge of the glass and to the skeleton. A sector is linked to two other sectors by articulations comprising a pivot link with substantially horizontal axis situated at its two ends of its length, except a chain-end sector, in which case it is linked only to one other sector by an articulation at one of its ends. A counter-skeleton with sectors can be composed of four bands (corresponding to the four sides of the glass and of the skeleton) each coming, in use, to face a side of the skeleton and therefore also a side of the glass. Each of these bands has a plurality of sectors, for example from 2 to 10 sectors. Thus, according to the invention, the counter-skeleton can comprise a metal bar of the vertical metal band type of which one edge is turned downward, comprising a plurality of sectors linked to one another by articulations, each articulation comprising a pivot link with substantially horizontal axis linking two sectors to one another.

By virtue of the articulations, the counter-skeleton with sectors closely follows the deformations of the glass. Likewise, its own tendency to be deformed is counteracted by the set of articulations. Thus, the counter-skeleton with sectors unstick much less from the glass than if it were of a single piece and without articulation. The marks on the glass depend essentially on the actual pressure exerted by the counter-skeleton on the glass, and therefore on the following parameters: the weight of the various sectors of the counter-skeleton, the contact surface of the fibrous material covering the counter-skeleton and, finally, the texture of the fibrous material itself which preferably has a small resilient surface. A system of counterweights, already described above, can be used to reduce the pressure of the sectors on the glass. In this case, the end of the lever linked to the counter-skeleton with sectors is linked preferably to an articulation joining two sectors.

Two sectors linked to one another by an articulation can be juxtaposed locally at the articulation. The areas of juxtaposition of the two sectors are then juxtaposed in a direction at right angles to the axis of the articulation, said axis passing through the zones of juxtaposition of the two sectors. The zone of juxtaposition of at least one of the two sectors can be, when seen from above, offset relative to its downward-turned edge, so as to form a space that can be occupied by the zone of juxtaposition of the other associated sector in the articulation. This local offset can in particular be produced by local embossing. This local offset can also be produced by cutting the zone of juxtaposition so as to form a tongue that can be offset by deformation of the metal relative to the plane of the sector when seen from above. In this way, even if, locally in the juxtaposed zones of the articulation the set of two articulated sectors is two times thicker than a single sector, the downward-turned edges of two sectors linked to one another by an articulation can be aligned when seen from above. Thus, the downward-turned edges of two sectors linked to one another by an articulation can be aligned when seen from above, the zone of juxtaposition of at least one of the two sectors being, when seen from above, offset relative to its downward-turned edge, so as to form a space occupied by the zone of juxtaposition of the other sector. A counter-skeleton with sectors can operate according to the modes V1 or V2 mentioned above and the advantage resulting from the existence of the articulations applies in both cases. In fact, the counter-skeleton with sectors is not deformed as much as if it were of a single piece. Its bottom edge follows the surface of the glass much better during the bending despite the thermal stresses. In this way, the pressure exerted by the counter-skeleton on the glass is more uniform and better distributed over all its zone of contact.

According to the mode V1, a counter-skeleton with sectors can touch the glass via a fibrous material whose compression is limited by virtue of the presence of a means of imposing a given minimal separation Dm between the metal band in the skeleton and the metal band in the counter-skeleton. For this, the skeleton can comprise a metal band whose edge is directed upward and a plurality of limit stops linked to the metal band. These limit stops are advantageously placed facing articulations of the counter-skeleton. Props are then linked to the counter-skeleton and placed facing the limit stops, notably to the rods forming axes of the articulations, so that they can come to bear on the limit stops, such that a minimal distance Dm between the metal band of the skeleton and the metal bar of the counter-skeleton can be imposed on each sector when the props rest on the limit stops, and therefore when the counter-skeleton is arranged on top of the glass. The articulations ensure that despite the thermal stresses, each sector rests on its associated limit stop. According to this construction, the sectors situated at the ends of each segment are slightly shorter in order to not hamper their movement about their horizontal axis.

A specific cutout at the articulation of the sectors situated at the ends of each band makes it possible to limit their vertical downward movement and thus not interfere with the movement of the counter-skeleton when the glass is loaded and unloaded. In effect, the sectors can be grouped into as many bands as the glass has sides, each band corresponding to a side of the glass and being substantially parallel to it, the ends of the bands not being linked to their neighboring bands.

The figures described hereinbelow are not to scale.

FIG. 1 represents in cross section a device according to the invention comprising a skeleton 320 and a counter-skeleton 321. A limit stop 327 is fixed to the metal band 322 of the skeleton. The upward-turned edge of this metal band is covered with a refractory fibrous material 323. The counter-skeleton comprises, as metal bar, a metal band 324 whose downward-turned edge is covered with a refractory fabric 325 to enter into contact with the glass 328. A prop 326 is linked to the metal bar 324 and can rest on the limit stop 327, blocking the descent of the counter-skeleton toward the skeleton. Off load (in a)), the gap E between skeleton and counter-skeleton is less than the thickness e of the glass 328. When the glass 328 is placed between these two tools (in b)), the refractory fibrous materials 325 and 323 are compressed under the weight of the counter-skeleton until the prop 326 rests on the limit stop 327. The gap between the bar 324 of the counter-skeleton and the metal band 322 of the skeleton is the minimum distance Dm. Limit stop 327 and prop 326 are a means of imposing a minimum distance between 324 and 322. In this way, the force of pressure on the glass exerted by the skeleton and the counter-skeleton is limited.

FIG. 2 represents a motor vehicle glazing of windshield type seen from above, and placed on a horizontal plane, concave face turned downward. It comprises four sides, two transverse sides 350 and 351 and two longitudinal sides 352 and 353. One side meets another side by a corner having small surface radii of curvature R (seen at right angles to the surface of the glass and in each corner) compared to the surface radii of curvature toward the middles of the sides. This glazing is symmetrical relative to the vertical plane of symmetry PS. This plane PS passes through the middles 354 and 355 of the transverse sides. This glazing rests on four points 356, 357, 358, 359 located in the corners. The segments 360, 361, 362 and 363 linking these four points have been plotted by dotted lines. These are the segments closest to the edges. An edge has an associated segment. Each of these segments has a middle 364, 365, 366, 367. For each segment, there is a plane (368, 369, 370, 371) at right angles to the segment and passing through its middle. Each of these planes intersects with the closest edge of the glass at a point 372, 355, 373, 354 which is the middle thereof. The glazing is concave (in this figure, the concave face is turned downward) at least at the middle points 372, 355, 373, 354 and in all the shaded zones on either side of these middle points, said concavity being considered parallel to the outer edge of the glazing. The same applies for the skeleton having supported this glass and for the zones of the skeleton corresponding to the zones of the middles of the sides of the glass, said concavity being considered parallel to the outlines (inner or outer) of the skeleton and seen from above in bending situation. The dotted line 376 is at 50 mm from the edge of the glass and forms the limit of the peripheral zone which is contained between the edge of the glass and this line. The zone of the middle of the side 353 of the peripheral zone of the top main face of the glass is the shaded zone on the left. This zone surrounds the middle point 373. The shaded zone is contained in the peripheral zone between the points 374 and 375 on the edge. These points 374 and 375 are each at a distance from the point 373 of at least 5 cm, even at least 10 cm, even at least 20 cm. The counter-skeleton presses on the glass at least in this zone and, if necessary, continuously throughout the length of this zone parallel to the edge of the glass, that is to say without discontinuity between the points 374 and 375, but not necessarily throughout the width of this zone.

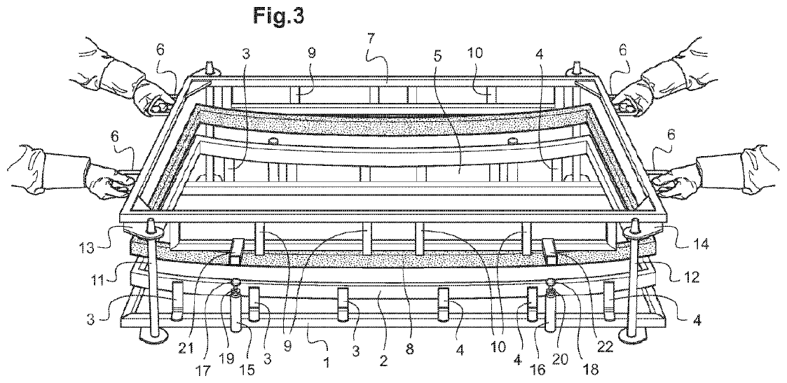

FIG. 3 represents a device according to the invention at the moment when a counter-skeleton 8 (greyed in the figure) is in the process of being placed in position on top of the glass, the latter not being represented in the figure in the interests of clarity. A frame 1 is distinguished on which is fixed the skeleton 2 via tabs 3 and 4. The glass (not represented) is placed on the skeleton 2. Operators hold the counter-skeleton 8 by handles 6. These handles are fixed onto a frame 7 to which the counter-skeleton 8 is also fixed via tabs 9 and 10. The exact positioning of the counter-skeleton is ensured by guidance by virtue of four positioning columns (11 and 12 in the foreground), one at each corner. These columns are secured to the frame 1. Tabs 13 and 14 fixed to the frame 7 of the counter-skeleton each comprising an orifice are threaded onto the columns 11 and 12 by their orifices. The pillars 15 and 16 form part of the means of imposing a given minimum distance Dm between the skeleton and the counter-skeleton. They are each provided with bearing surfaces 17 and 18 that are adjustable heightwise via screws 19 and 20. The frame 7 of the counter-skeleton comprises tabs 21 and 22 which will rest on the bearing surfaces 17 and 18 when the operators have finished placing the counter-skeleton. The weight of the counter-skeleton therefore rests on the bearing surfaces 17 and 18, the height thereof being so that the separation between the counter-skeleton and the skeleton is the chosen height. The bearing surfaces 17 and 18 form limit stops secured to the skeleton and the tabs 21 and 22 are props secured to the counter-skeleton. The skeleton and the counter-skeleton here form a carted assembly capable of being displaced horizontally in a kiln. The four positioning columns (11 and 12 in the foreground) form part of vertical translation means allowing the skeleton and the counter-skeleton to move closer to or away from one another by a relative vertical movement without horizontal displacement relative to one another. In this way, the skeleton and the counter-skeleton remain facing one another (on either side of the glass) during the horizontal displacement of the skeleton/counter-skeleton assembly in the kiln.

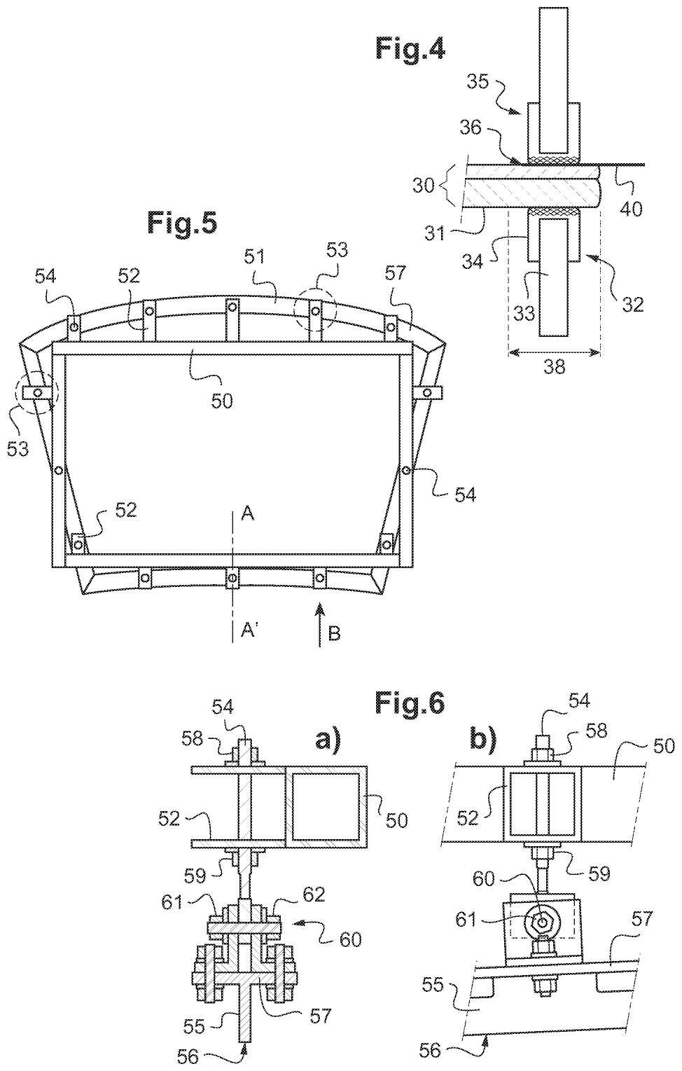

FIG. 4 represents a part in cross section of the device according to the invention in which there is a stack 30 of two sheets of glass comprising a thin sheet (for example 1.1 mm thick) in the top position and a thicker sheet (for example 2.1 mm thick) in the bottom position. The gap between the glass and the counter-skeleton (and also therefore between the skeleton and the counter-skeleton) is being adjusted using the shim 40. This operation is done on a glass previously already bent. The glass rests on its bottom main face 31 on the skeleton 32, which is composed of a metal band 33 and of a fibrous refractory material 34 covering the contact surface for the glass. The counter-skeleton 35 has the same structure. Skeleton and counter-skeleton are exactly facing one another on either side of the glass. There is a separation 36 between the counter-skeleton 33 and the top face of the glass 37, filled by the adjustment shim 40. Skeleton and counter-skeleton act entirely within the peripheral zone 38 of the glass contained between the edge of the glass and 50 mm from the edge of the glass.

FIG. 5 represents, in plan view, a counter-skeleton comprising a rigid structural element 50 above a part 51 of the counter-skeleton comprising a vertical flat (not visible) coming onto the glass. The visible part 51 is a horizontal flat 57 coming above the vertical flat and to which it is linked. This structural element is a metal tube of square section and has the form of a rectangular frame in plan view. It comprises a plurality of extensions 52 linked to its inner or outer vertical faces, said extensions coming, in plan view, above zones 53 of local adjustment of the position of the bottom edge of the counter-skeleton. These adjustments are made by jack screws 54 here passing through the rigid structural element 50.

FIG. 6 shows the counter-skeleton of FIG. 5 according to the section AA′ in a) and the side view according to the direction B in b). There is the metal square of the rigid structural element 50, an extension 52 being welded to an outer vertical face of said square. This extension is also in the form of a metal square. The vertical flat 55 is linked indirectly to the rigid structural element 50 such that it is secured thereto. The bottom rim 56 of this vertical flat 55 comes onto the glass and its distance to the skeleton can be finely adjusted by the screw jack 54 by screwing or unscrewing the nuts 58 and 59. The vertical flat 55 is welded by its top rim to a horizontal flat 57, in order to stabilize the position of the flat 55. The horizontal flat 57 is linked to the bottom end of the jack screw 54 via a pivot link 60, the pivoting of which can be adjusted and blocked in a given position by virtue of the nuts 61 and 62. The adjustment of this pivoting makes it possible to adjust the inclination of the rim 56 in order for the latter to be correctly parallel to the skeleton and for the distance between the skeleton and the counter-skeleton to be correctly constant over all the periphery of the glass.

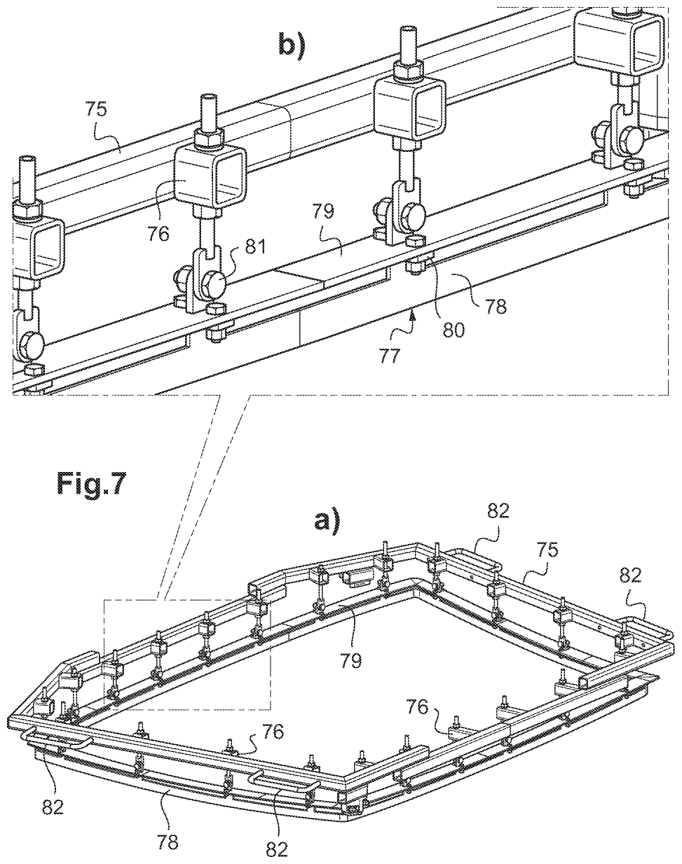

FIG. 7 represents a counter-skeleton according to the invention seen entirely in a), a part thereof being enlarged in b). This counter-skeleton comprises a structural element 75 produced from pieces of metal squares welded together. Seen from above, this structural element has a form similar to that of the skeleton and therefore of the glass to be bent. Lateral extensions 76 have been welded onto inner vertical faces of the structural element. Adjusting jack screws pass vertically through these extensions. The adjustment of a jack screw makes it possible to locally adjust the dimension of the bottom rim 77 of a vertical flat 78. This vertical flat is secured to a horizontal flat 79 by a system of brackets 80 and of screws and nuts. A pivot link 81 on top of the horizontal flat 79 makes it possible to adjust the local inclination of the horizontal flat 79 as part of the adjustment of the heightwise dimension of the rim 77. Also distinguished are handles 82 allowing operators to manipulate this counter-skeleton and to place it on top of the glass. The correct lateral positioning of the counter-skeleton is ensured by virtue of a centering means of the type of that already described for FIG. 3 and not represented here in the interests of simplification.

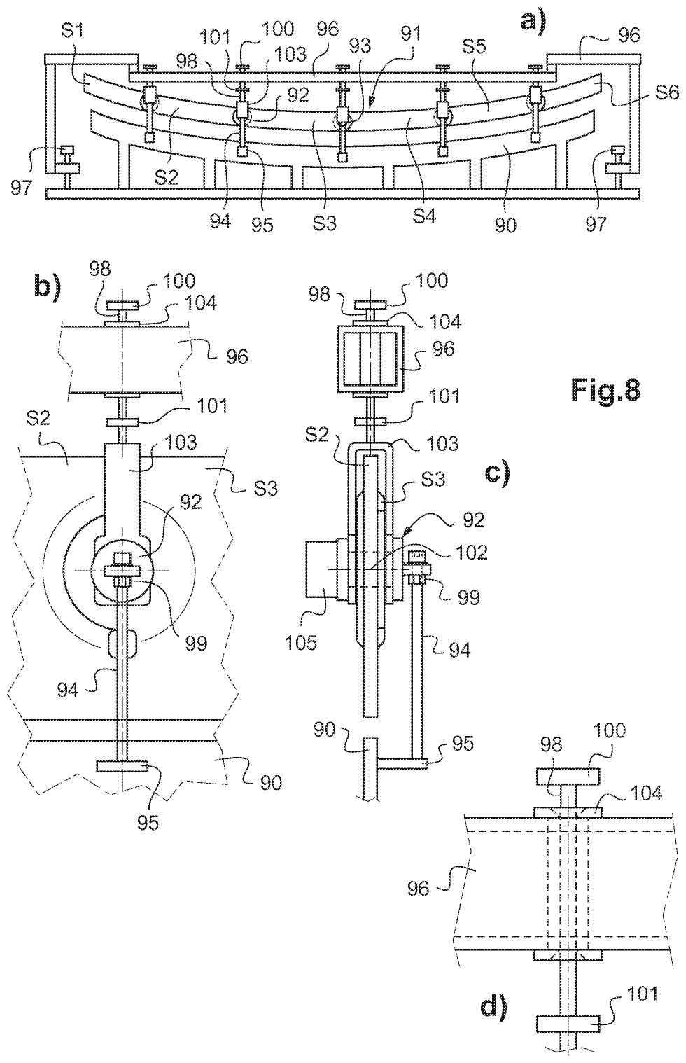

FIG. 8 shows, in side view and schematically, the assembly of a skeleton 90 and of its counter-skeleton 91. It can be seen that the contact track of the skeleton is concave over all the length of the visible side in the figure, parallel to its inner and outer contours, this concavity being in the plane of the figure. The counter-skeleton 91 is composed of a plurality of sectors (S1, S2, S3, S4, S5, S6) linked to one another by articulations. A sector has an elongate dimension parallel to the edge of the glass that is called length L (substantially horizontal in FIG. 8a), and a height (substantially vertical in FIG. 8a). Two sectors linked by an articulation exhibit a juxtaposition locally in the zone of the articulation. FIG. 8b) represents, in side view, a zoom of the pivot articulation 92 between the sectors S2 and S3 (of FIG. 8a) and of the associated limit stop and prop system. FIG. 8c) represents the same as FIG. 8b) but seen in the lengthwise direction of the sectors, the eye being on the side of the sector S2 and looking in the direction of the sector S3. In order to simplify the figures, the edges hidden in FIGS. 8a) to 8d) have not been represented and the fibrous material covering the tools has likewise not been represented. The counter-skeleton comprises a rigid structural element 92 whose heightwise dimension relative to the skeleton 90 is adjusted beforehand and approximately by jack screws 97 situated at the four corners of the counter-skeleton. The plurality of sectors S1 to S6 linked to one another by articulations (92, 93) in the manner of a chain form an articulated vertical flat. A sector S3 is linked by each of its ends to two neighboring sectors S2 and S4 by pivot links 92 and 93 with substantially horizontal axes. These articulations allow the possibility of the sectors to move relative to one another simply under the effect of their own weight. Each sector is provided with a rod 94 serving as prop and coming to bear on a limit stop 95 secured to the skeleton 90. When the heightwise-adjustable prop 94 bears on the limit stop 95, the desired skeleton/counter-skeleton gap is obtained. The lock nut 99 makes it possible to block the screw 94 and thus fix the skeleton/counter-skeleton gap. The pivot link 92 represented in FIG. 8c is composed of a horizontal axis 102 linking two sectors S2 and S3 which is linked to a bridge 103 which straddles the two sectors S2 and S3. The sectors S2 and S3 can therefore be moved freely in rotation relative to the bridge 103 and about the axis 102. A rod 98 is linked to each articulation axis via a bridge identical to the bridge 103 and can have a free vertical movement relative to the rigid structural element 96. As shown in detail in FIG. 8d), a runner 104 is inserted between the rigid structure 96 and the vertical rod 98. A mechanical play of between 0.3 and 0.5 mm between the inner bore of the runner 104 and the vertical rod 98 makes it possible to obtain a good mechanical compromise between the possible vertical translation of the rod 98 and the accuracy of its vertical guidance. This rod 98 is topped by a head 100 in order for the rod not to be able to pass through the rigid structural element 96. When the counter-skeleton is removed, each head comes to rest on the rigid structural element 96, which makes it possible simply to keep a cohesion of all of the sectors. Likewise, a limit stop 101 is also arranged on the rod 98 but this time under the rigid structure 96 in order to limit the upward movements of the sectors, in case of manipulation of the counter-skeleton in particular. A counterweight 105 (shown in FIG. 8c) has been arranged at each articulation but on the side opposite the adjustable prop 94. Such a counterweight makes it possible to counterbalance the weight exerted by the prop 94 and thus to favor the slip of each rod 98 in its runner 104. When the counter-skeleton is in position as in FIG. 8a), then the heads 100 do not rest on the rigid structural element 96, such that it is the position of the limit stops and props which determine the position of the sectors. The rigid structural element 96 then serves no reference role. During a thermal cycle, the sectors can move relative to one another by the play of the articulations such that the props always rest on the limit stops, which guarantees the retention of the desired skeleton/counter-skeleton gap during the thermal cycle.

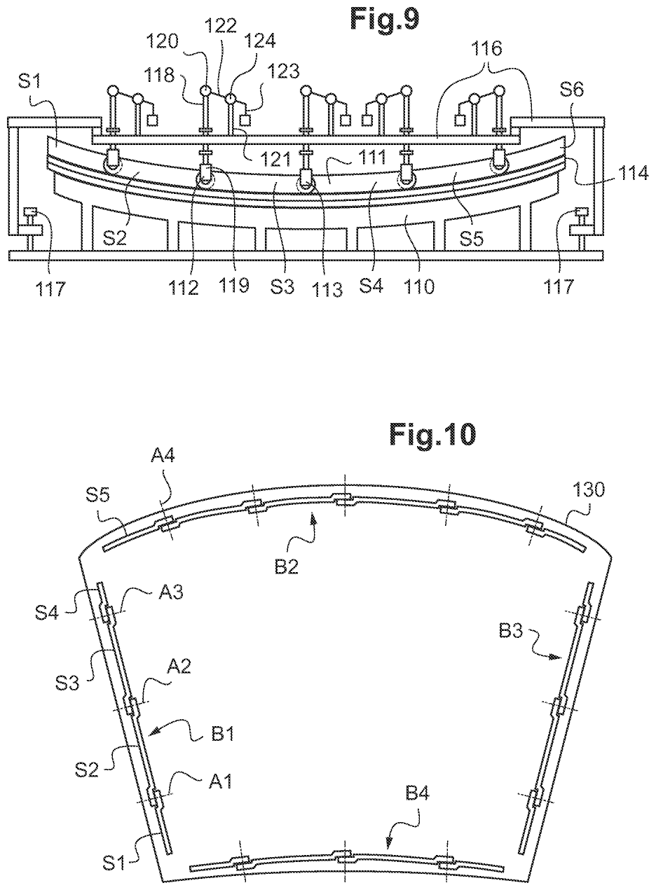

FIG. 9 shows, in side view and schematically, the assembly of a skeleton 110 and of its counter-skeleton 111 composed of a plurality of sectors (S1, S2, S3, S4, S5, S6) linked to one another by pivot articulations with substantially horizontal axes. Contrary to the case of FIG. 8 (where the minimum skeleton/counter-skeleton gap is set using a combination of limit stops and props arranged at each articulation), the tool is used here with direct pressure, without any system of limit stops and props. FIG. 9 schematically represents a counterweight system which can be installed at the ends of the rods 118 in order to lighten the effective weight of each sector, and therefore the contact pressure that the counter-skeleton exerts on the glass 114 during bending. The counter-skeleton comprises a rigid structural element 116 whose heightwise dimension relative to the skeleton 110 is adjusted beforehand and approximately by jack screws 117 situated at the four corners of the counter-skeleton. The plurality of sectors S1 to S6 linked to one another by articulations (112, 113) in the manner of a chain, form an articulated vertical flat. A sector S3 is linked by each of its ends to two neighboring sectors S2 and S4 by pivot links 112 and 113 with substantially horizontal axes. These articulations allow the possibility for the sectors to move relative to one another under the sole effect of their own weight. The articulation 112 is linked by a bridge 119 which straddles the ends of the two sectors S2 and S3.

The sectors S2 and S3 can therefore be moved freely in rotation relative to the bridge 119 and according to the articulation 112. A rod 118 is linked to the articulation 112 via a bridge 119 and can have a free vertical movement relative to the rigid structural element 116. This rod 118 is topped by an articulation 120. The counterweight system is composed of a vertical bar 121 provided with an articulation 124 at its top end, of a rod 122 revolving, at a point situated between its ends, freely about the articulation 124 and of a weight 123 attached to the end of the rod 122. The bar 121 is secured to the rigid structure 116 and situated in proximity to the rod 118. The second end of the rod 122 is linked to the articulation 120 linked to the rod 118.

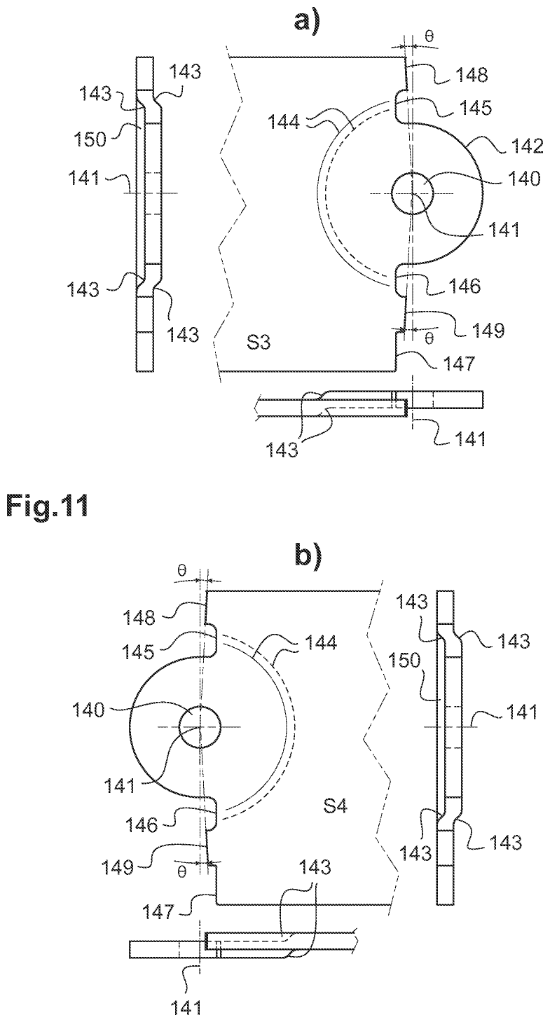

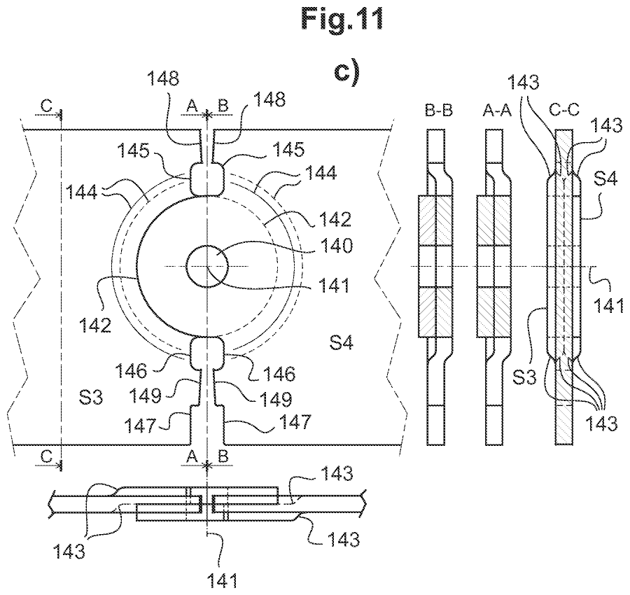

FIG. 10 shows schematically, in plan view, all of the sectors which make up the counter-skeleton according to the invention and described in FIG. 8. The sectors are grouped in as many bands as the glass has sides (four bands B1, B2, B3 and B4), each band corresponding to a side of the glass, the ends of the bands not being linked to their neighboring bands. For simplification reasons, only the different sectors (S1, S2, S3, S4, S5, etc.), their rotation axes (A1, A2, A3, A4, etc.) and the outer perimeter of the glass 130 have been represented. The sectors positioned at the ends of each band (such as, for example, the sectors S1, S4 and S5) are not linked to the neighboring sector belonging to an immediately adjacent band. They are slightly shorter in order to allow a free movement about their horizontal axis without interference with the neighboring sectors belonging to an adjacent band. A means described in FIGS. 11 to 13, but not represented here, makes it possible to limit the downward displacement of the sectors situated at the ends of the bands. Thus, the sectors situated at the ends do not come to interfere with the glass in the loading and the unloading of the counter-skeleton.

FIG. 11 shows different representations of the ends of two adjacent sectors of a counter-skeleton with sectors such as the sectors S3 and S4 of FIG. 8 intended to be linked by an articulation. FIG. 11a) represents the end of a sector, such as the sector S3 of FIG. 8a), in front, plan and side views. FIG. 11b) is similar to FIG. 11a) but represents the adjacent sector, such as the sector S4 of FIG. 8a). FIG. 11c) represents the assembly of the two ends of sectors arranged as articulated, such as the sectors S3 and S4 of FIGS. 8a) and 8b) in front view, plan view as well as three vertical cross-sectional views, two of which are situated in the vertical plane passing through the articulation axis between the sectors S3 and S4. To form the articulation, a rod (not represented) is passed into the hole 140, the axis of said rod corresponding to the axis 141. FIG. 11 shows that an appropriate cutout combined with a local embossing of the sectors in the zone of their articulation makes it possible to obtain a downward-turned face of constant width all along the band, without doubling the thickness at the articulations, which would be the case if the sectors, kept entirely flat, were simply juxtaposed. In fact, the contact tracks with the glass of the two sectors are well aligned in plan view. Each sector S3 and S4 is composed of a steel plate. Their cutout is symmetrical and is shown in front view in FIGS. 11a) and 11b). A hole 140 of axis 141 is provided at their end to allow the passage of the articulation axis. The end 142 of the sector S3 is cut out in half-ring form around the hole 140. Moreover, an embossing in the form of a disk of diameter greater than the half-ring 142 and of axis 141 makes it form a boss of half the thickness of the component steel plate S3 or S4. The deformations 143 by embossing of the steel plates are visible in the plan and side views and are schematically represented by fine lines 144 on the front views. Through this bossing, the zone of juxtaposition of a sector is, in plan view, offset relative to its downward-turned edge. This bossing forms a space 150 in which the zone of the articulation of a neighboring sector can be placed in order to form the articulation. Thus, the bosses of two sectors intended to be linked together by an articulation are complementary and allow the local juxtaposition of the two sectors of the articulation without thickening the downward-turned edge of the assembly of the two sectors. The assembly of the two assembled sectors is only thicker locally in the zones of juxtaposition of the sectors to form the articulation. These juxtaposition zones are juxtaposed in a direction at right angles to the axis of the articulation, which passes through the zones of juxtaposition of the two sectors. The downward-turned edges of the two sectors linked to one another by an articulation are aligned in plan view. Two notches 145 and 146 are cut out in the steel plate in order not to provoke any edge effect which could disrupt the rotational movement of the two sectors S3 and S4 relative to one another. Finally, a notch 147 is formed in the bottom part of each sector in order to form a recess that makes it possible to hold a fibrous material covering the bottom edge of the sectors. Two protruding parts 148 and 149, one (148) in the top part of each sector and the other (149) in the bottom part of each sector, are cut out along a line which passes through the axis of rotation 141 and which forms an angle θ with the vertical. This angle is present both to allow and limit the rotation of the two sectors relative to one another. In particular, the protruding parts 149 facing the two adjacent sectors can form limit stops by meeting one another, which makes it possible to limit the downward displacement of the sectors situated at the ends of the bands, particularly when the counter-skeleton is removed from the device.

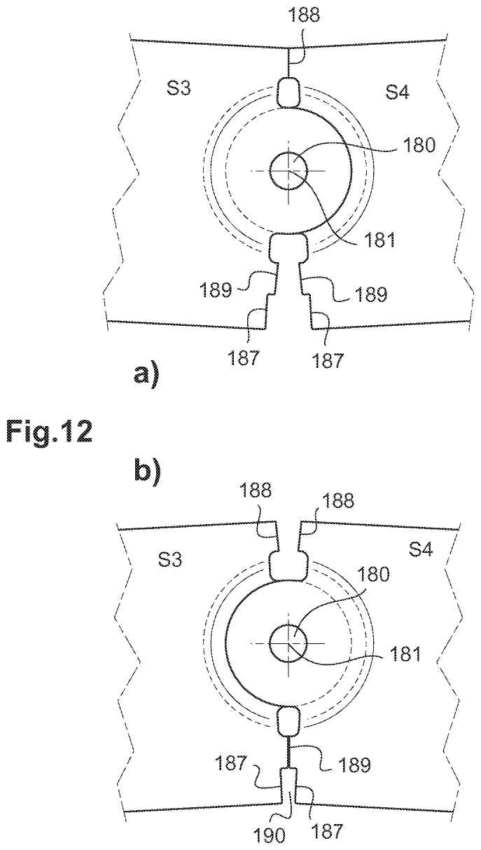

FIG. 12 presents, in front view, two adjacent sectors of a counter-skeleton with sectors of a form identical to the sectors S3 and S4 of FIG. 11. These two sectors are centered along a common axis 181. FIG. 12a represents the two sectors S3 and S4, each being displaced upward while the axis of their common articulation remained in a lower position. On the contrary, FIG. 12b represents the two sectors S3 and S4, each being displaced downward while the axis of their common articulation remained in a higher position. The objective of FIG. 12 is to show that the appropriate cutout of the ends of the sectors S3 and S4 makes it possible to limit the relative angular travel of S3 and S4. The maximum angle that the sectors can form between them is limited by the parts 188 and 189 which act as limit stops. This angle is two times the angle θ of FIG. 11. The notches 187 make it possible to fix a fibrous material covering the bottom edge of the sectors. In fact, FIG. 12b shows the two sectors in closed position at the bottom and it can be seen that the space 190 between the notches 187 remains sufficient to allow the fibrous material to pass. The protruding parts 189 facing the sectors S3 and S4 can form limit stops by meeting one another (FIG. 12b), which makes it possible to limit the downward displacement of the sectors situated at the ends of the bands, particularly when the counter-skeleton is removed from the device.

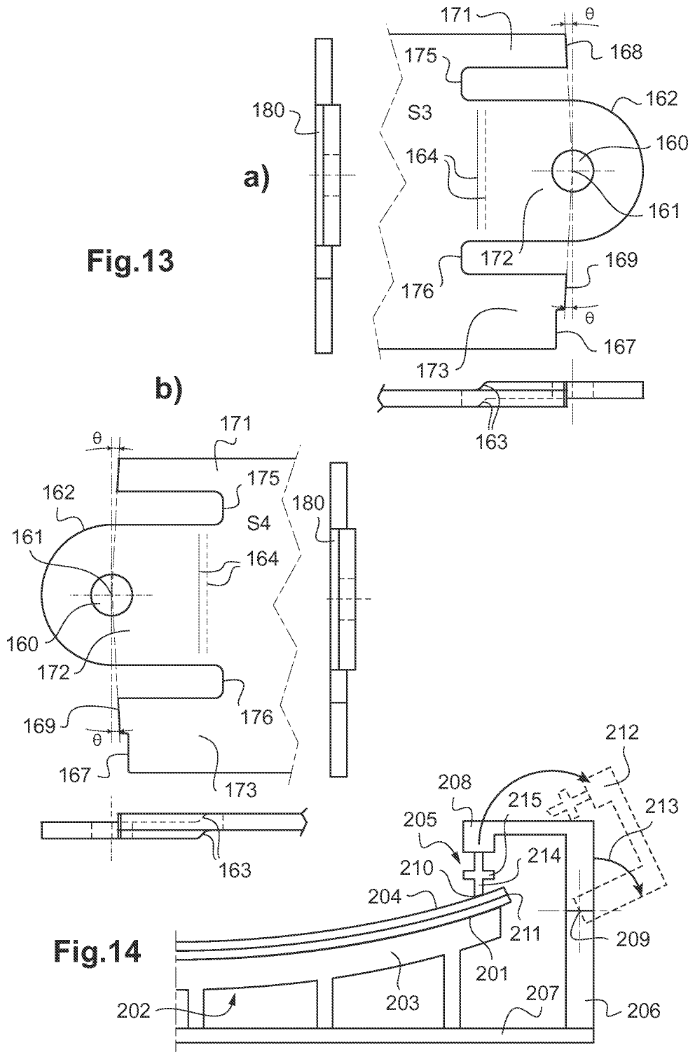

FIG. 13 presents an alternative that is simple to fabricate of ends of sectors of counter-skeleton with sectors. FIG. 12a represents the end of a sector, such as the sector S3 of FIG. 8a, in front, plan and side views. FIG. 12b represents the adjacent sector, such as the sector S4 of FIG. 8a, that has to be linked by an articulation with the sector of FIG. 13a. There is a half-ring 162 surrounding a hole 160 of axis 161, for these two sectors, the axis 161 being that of the articulation. The end of the sectors is roughly composed of three tongues 171, 172 and 173. The top tongue 171 is composed of a protruding part 168 which makes it possible to limit the closure of the two sectors S3 and S4 as already explained for the sectors of FIG. 12. This protruding part 168 forms an angle θ with the vertical. The tongues 171 and 172 on the one hand and 172 and 173 on the other hand are respectively separated by two re-entrant cutouts 175 and 176 which make it possible essentially to perform a simple folding of the central tongue 172 rather than a circular embossing such as that presented in FIG. 11. Such a folding is easier to produce than an embossing. The deformations of the central tongue 172 are visible in the plan views and are schematically represented in fine lines 164 in the front views. The tongue 172 comprises the zone of juxtaposition of the articulation. The offset of the tongue 172 induced by the deformations 164 forms a space 180 that is useful to the placement of the zone of juxtaposition of the neighboring sector to form the articulation of axis 161. The bottom tongue 173 is composed of a protruding part 169 which makes it possible to limit the closure of the two sectors S3 and S4 by forming a limit stop. This protruding part 169 forms an angle θ with the vertical. Finally, a notch 167 in the bottom part of each sector forms a space necessary to the passage of the fibrous material covering the bottom edge of the sectors.

FIG. 14 represents, in cross section, a schematic view of a counter-skeleton 205 comprising laterally retractable bands. For simplification, just one side 205 of the counter-skeleton has been represented, and this is seen in its lengthwise direction. The glass rests by its bottom main face 201 on the skeleton 202, which comprises a metal band 203 of which one edge is directed upward. The counter-skeleton comprises, as metal bar, a vertical flat 214 and a horizontal flat 215. Skeleton and counter-skeleton are both provided with a refractory fibrous material (not represented) to come into contact with the glass. The counter-skeleton 205 is secured to an inverted U-shaped structure 208. The latter is linked to a foot 206 which is itself secured to the structure 207 of the skeleton 202 via a pivot link of substantially horizontal axis 209. During the bending, the counter-skeleton touches the top main surface of the glass 210. The pivot link makes it possible to retract the assembly of ‘counter-skeleton plus “U”-shaped structure’ once the bending of the glass has been performed, which makes it possible to easily release the bent glass. The assembly of ‘counter-skeleton plus “U”-shaped structure’ is represented in retracted position by dotted line 212. The position of the axis of rotation 209 of the structure of the counter-skeleton, both fairly high and away from the edge of the glass 211, which allows the counter-skeleton to be moved away from the glass by a rotational movement (arrow 213) driving it both upward but also laterally. The retraction system is produced by a triggering system not described here but that can for example pass through the lateral walls of the kiln or else the bed of the kiln. The retraction performed during cooling makes it possible to obtain good glass edge stresses. Moreover, the retraction also makes it possible to remove the glass from the skeleton by a conventional harrow system pushing it from below, and to load it easily at the kiln entry, using a robot for example. The counter-skeleton is put back in place by an inverse rotary movement once the next glass is loaded on the skeleton.

1. A device for bending by gravity a sheet of glass or a stack of sheets of glass comprising a plurality of sides, comprising a skeleton for supporting the glass in its peripheral zone by a contact track, said contact track comprising concave curvatures on each of the sides of said skeleton, and a counter-skeleton capable of entering into contact with the glass in a zone of the middle of at least one side of the peripheral zone of a top main face of the glass.

2. The device as claimed in claim 1, wherein the device is configured to give the glass forms that are concave when seen from above in its central zone and on each of its sides.

3. The device as claimed in claim 1, wherein the counter-skeleton enters into contact in the zone of the middle of all of the sides of the peripheral zone of the top main face of the glass.

4. The device as claimed in claim 1, wherein the zone of the middle of at least one side comprises 5 cm on either side of the middle parallel to the edge of the glass and in the peripheral zone.

5. The device as claimed in claim 1, wherein the counter-skeleton enters into contact with the glass by a refractory fibrous material.

6. The device as claimed in claim 5, wherein the fibrous material is capable of being compressed under the effect of the force of gravity acting on the counter-skeleton.

7. The device as claimed in claim 6, wherein a counterweight system linked to the counter-skeleton reduces the pressure force of the counter-skeleton on the glass.

8. The device as claimed in claim 1, wherein the skeleton comprises a metal band an edge of which is directed upward, said edge being covered by a refractory fibrous material forming the contact track for the glass, the counter-skeleton comprises a metal bar, the device comprising a means for imposing a given minimum distance Dm between the metal band of the skeleton and the metal bar of the counter-skeleton.

9. The device as claimed in claim 8, wherein the means for imposing Dm comprises a limit stop-forming element secured to the metal band of the skeleton and on which a prop secured to the metal bar of the counter-skeleton can rest.

10. The device as claimed in claim 1, wherein the means for imposing Dm is adjustable.

11. The device as claimed in claim 1, wherein the counter-skeleton comprises a metal bar of metal band type whose edge is turned downward, comprising a plurality of sectors linked to one another by articulations, each articulation comprising a pivot link with substantially horizontal axis linking two sectors to one another.

12. The device as claimed in claim 11, wherein the ends of two sectors are linked to one another by an articulation, these ends each comprising an adjoining zone, these adjoining zones being adjoined in a direction at right angles to the axis of the articulation, said axis passing through the joining zones of the two sectors.

13. The device as claimed in claim 12, wherein the downward-turned edges of two sectors linked to one another by an articulation are aligned when seen from above, the adjoining zone of at least one of the two sectors being, when seen from above, offset relative to its downward-turned edge, so as to form a space occupied by the adjoining zone of the other sector.

14. The device as claimed in claim 11, wherein the sectors are grouped in as many bands as the glass has sides, each band corresponding to a side of the glass, the ends of the bands not being linked to their neighboring bands.

15. The device as claimed in claim 11, wherein the skeleton comprises a metal band an edge of which is directed upward and a plurality of limit stops linked to the metal band and placed facing articulations of the counter-skeleton, props being linked to the counter-skeleton facing the limit stops to come to bear on the limit stops, such that a minimum distance Dm between the metal band of the skeleton and the metal bar of the counter-skeleton can be imposed on each sector when the props rest on the limit stops.

16. The device as claimed in claim 1, further comprising a progressive system capable of progressively modifying, during the bending, the distance between the skeleton and the counter-skeleton.

17. The device as claimed in claim 1, wherein the counter-skeleton comprises a metal bar and a structural element arranged above the metal bar, the structural element and the metal bar being linked to one another by a plurality of adjustable spacers making it possible to locally adjust the distance between the structural element and the metal bar.

18. The device as claimed in claim 1, wherein the counter-skeleton is removable.

19. The device as claimed in claim 1, wherein the counter-skeleton comprises laterally retractable bands.

20. The device as claimed in claim 1, further comprising means allowing the skeleton and the counter-skeleton to approach or move away from one another by a relative vertical movement without relative horizontal displacement relative to one another.

21. The device as claimed in claim 1, further comprising a kiln and a conveyor capable of horizontally displacing together the skeleton and the counter-skeleton in the kiln while they are facing one another, and vertical translation system allowing the skeleton and the counter-skeleton to approach or move away from one another by a relative vertical movement during their horizontal displacement and without relative horizontal displacement of one relative to the other.

22. The device as claimed in claim 1, wherein the counter-skeleton is capable of exerting a weight on the glass per linear meter of counter-skeleton less than 2 kg/m and greater than 0.1 kg/m.

23. A method for bending a sheet of glass or a stack of sheets of glass comprising a plurality of sides, by the device of claim 1, the method comprising the bending of the glass by gravity on a skeleton supporting the glass in its peripheral zone by a contact track, said contact track comprising concave curvatures on each of the sides of said skeleton, a counter-skeleton coming into contact with the glass in a zone of the middle of at least one of the sides of the glass in the peripheral zone of its top main face.

24. The method as claimed in claim 23, wherein the glass takes a concave form when seen from above in its central zone and on each of its sides.

25. The method as claimed in claim 23, wherein the counter-skeleton comes into contact with the zone of the middle of all of the sides of the glass of the peripheral zone of the top main face of the glass.

26. The method as claimed in claim 23, wherein the counter-skeleton comes into contact with the glass by a refractory fibrous material.

27. The method as claimed in claim 26, wherein the refractory fibrous material is compressed during the bending under the effect of the force of gravity acting on the counter-skeleton.

28. The method as claimed in claim 23, wherein the skeleton comprises a metal band an edge of which is directed upward, said edge being covered with a refractory fibrous material forming the contact track for the glass, said refractory fibrous material being compressed during the bending under the effect of the pressure exerted by the bottom face of the glass.

29. The method as claimed in claim 28, the counter-skeleton comprising a metal bar whose bottom face is covered with refractory fibrous material, the compression of the refractory fibrous material with which the skeleton and the counter-skeleton are equipped being limited by a means capable of imposing a minimum distance Dm between the metal band of the skeleton and the metal bar of the counter-skeleton.

30. The method as claimed in claim 23, wherein the skeleton and the counter-skeleton approach one another progressively during the bending.

31. The method as claimed in claim 23, wherein the peripheral zone is the zone between the edge of the glass and a distance from the edge of the glass of 50 mm.

32. The method as claimed in claim 23, wherein the glass is a stack of sheets of glass.

33. The method as claimed in claim 23, wherein the glass is bent at a temperature lying within the 570 to 650° C. range.

34. The method as claimed in claim 23, wherein, during the bending, the counter-skeleton exerts a weight on the glass per linear meter of counter-skeleton less than 2 kg/m and greater than 0.1 kg/m.

35. The method as claimed in claim 23, wherein the skeleton and the counter-skeleton are conveyed together into a kiln while the skeleton and the counter-skeleton are facing one another on either side of the glass, the glass being in contact with the skeleton for more than 10 minutes in the kiln and the counter-skeleton touching the glass for more than 10 minutes in the kiln.
